(19) United States
(12) Patent Application Publication
(10) Pub. No.: US 2007/0182181 A1
(43) Pub. Date: Aug. 9, 2007

(54) Mobile variable display system

(76) Inventors: Benjamin Cohen, Brooklyn, NY (US); Asher Hazan, (US)

Correspondence Address: BERNARD MALINA, ESQ.;MALINA & ASSOCIATES, P.C., Suite 501, 60 East 42nd Street, New York, NY, 10165, US

(21) Appl. No.: 11/545,199

(22) Filed: Oct. 10, 2006

Related U.S. Application Data
(60) Provisional application No. 60/725,459, filed on Oct. 11, 2005.

(51) Int. Cl. B60R 13/00

(52) U.S. Cl. 296/21

(57) ABSTRACT

A display system includes a self-powered vehicle and a display unit which is mounted on the vehicle. The display unit includes a plurality of display panels which are mounted in frame members. In the primary embodiment, the display panels are solid panels. In alternative embodiments, the display panels are translucent or transparent and the display unit includes a set of lamps which provide an illuminated display.

This application claims priority from U.S. Provisional Patent Application No. 60/725,459, filed Oct. 11, 2005, titled “Mobile Variable Display System.”

### BACKGROUND OF THE INVENTION

The present invention generally relates to mobile advertising and more particularly, to mobile advertising displays which are highly maneuverable in dense city traffic.

Mobile advertising systems are known in the prior art. By way of example, U.S. Pat. No. 6,702,351 to Buring, et al., discloses a mobile multi-display billboard vehicle comprising a cab and a flat bed portion with a sign box mounted on the flat bed portion and an electromechanical display system. The electromechanical system for selectively varying the displays in the Buring mobile advertising vehicles is complex and, therefore, relatively expensive to manufacture and operate. Second, such display vehicles, due to their size, are cumbersome and difficult to operate, particularly in dense vehicular and pedestrian traffic, which is a particularly desirable area for display advertising.

Other mobile advertising systems which comprise a trailer mounted billboard involve similar disadvantages. Rather than eliciting a favorable reaction from the public, due to their bulk and lack of maneuverability, such trailer systems generate ill will among other car drivers and pedestrians who are the very object of the advertising efforts.

Despite the developments of the prior art, there remains a need for a mobile variable display system which can be operated effectively in the midst of dense vehicular and pedestrian traffic.

### OBJECTS AND SUMMARY OF THE INVENTION

It is an object of the present invention to provide a mobile vehicular display system which can be easily maneuvered.

Another object of the present invention is to provide a mobile variable display system in which the display can be easily changed.

Another object of the present invention is to provide a mobile variable display system which is economical to manufacture.

Another object of the present invention is to provide a mobile variable display system which is highly maneuverable in vehicular and pedestrian traffic such as shopping areas thereby facilitating safe operation in areas which are highly desirable for mobile advertising.

Yet another object of the present invention is to provide a mobile variable display system which comprises a relatively small number of relatively simple components thereby resulting in reliable long term operation.

Another object of the present invention is to provide a mobile vehicular display system which incorporates an illuminated display.

Other objects and advantages of the present invention will be apparent hereinafter.

In accordance with the present invention, there is provided a mobile variable display system which includes a self-powered vehicle and a display unit which is mounted on the self-powered vehicle. The display unit includes a framework comprising frame members which include slotted portions. Display panels are slideably mounted in the slotted portions. The slotted portions facilitate changing the display panels to update the advertising or informational messages which are imprinted thereon.

In an alternative embodiment of the invention, the display panels are transparent or translucent and the display panels are illuminated by a light source which is mounted in an interior area defined by the display panels.

### BRIEF DESCRIPTION OF THE DRAWINGS

Other objects and advantages of the present invention will be made clear in the following description when taken in connection with the following drawings:

FIG. 1 is an overall perspective view of a mobile variable display system made according to the present invention;

FIG. 2 is an overall perspective view of the display unit with the display unit shown removed from the mobile variable display system of FIG. 1 and showing a first embodiment of the invention;

FIG. 3 is a fragmentary side elevation view of the display unit of FIG. 2 taken along the line 3-3 in FIG. 2;

FIG. 4 is a top plan view of the display unit of FIG. 2 with the top panel removed and taken along the line 4-4 of FIG. 3;

FIG. 5 is an exploded view of an alternate top panel for use with the display unit of FIG. 2 and forming a second embodiment of the invention;

FIG. 6 is a fragmentary cross-sectional view generally similar to FIG. 4 showing a third embodiment of the invention in which the solid display panels of FIG. 4 are replaced by translucent display panels;

FIG. 7 is a fragmentary perspective view of an illumination system which forms part of the third embodiment of the invention; and

FIG. 8 is an overall perspective view of an alternative display unit which forms a fourth embodiment of the invention.

### DETAILED DESCRIPTION OF THE INVENTION

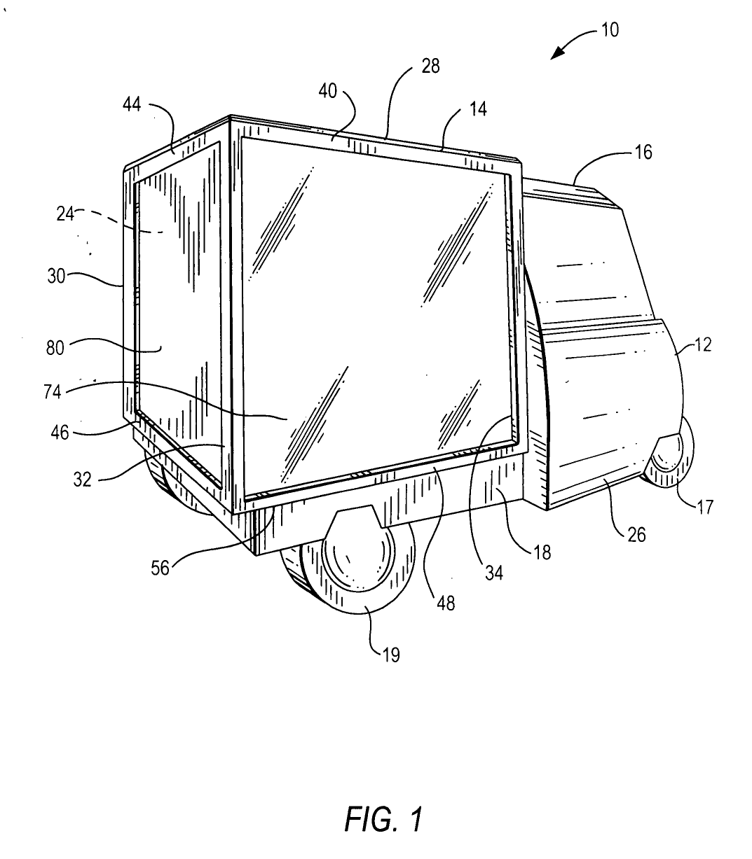

With reference to the drawings wherein there is shown in FIGS. 1-8 a mobile vehicular display system 10 which includes self-powered vehicle 12 and a display unit 14. The self-powered vehicle 12 includes a cab section 16 with a steerable single wheel 17 and a rear section 18 riding on two wheels 19 on which is mounted a box-like display frame unit 14 is mounted. The self-powered vehicle 12 is generally similar to three-wheel vehicles used for city traffic enforcement and mail delivery. The sign display area of the display unit 14 has one or more removable display panels 74, 76, 78, 80 which may be slidably or otherwise mounted into the display unit 14. The display panels 74, 76, 78, 80 may comprise a conventional billboard poster display mounted on a flat sheet-like support. Alternatively, display panels may be in the form of sheets of transparent or translucent materials 302 with illumination supplied by lighting 306 mounted in a space behind the display panels 302.

In the preferred embodiment of the invention, the vehicle 12 is a commercially available vehicle which is typically identified in the industry as a Cushman utility vehicle. This vehicle is manufactured by the McKinley Equipment Corporation located in Irvine, Calif. Alternate vehicles which have a front steerable wheel and two rear wheels and having a wheel base distance between the two rear wheels in the order of 20 to 60 inches and a distance between the rear axle and the front wheel in the order of 20 to 60 inches may be utilized.

The self-powered vehicle 12 is highly maneuverable in dense city traffic which is the area most favorable for mobile display advertising. The vehicle 12 may advantageously carry additional advertising material on the side doors 26 of the cab 16 thus maximizing the area available for advertising material. Further, the roof of the display unit 14 also includes an additional display panel 28 which is viewable from high rise office buildings, apartment houses, or other elevated locations.

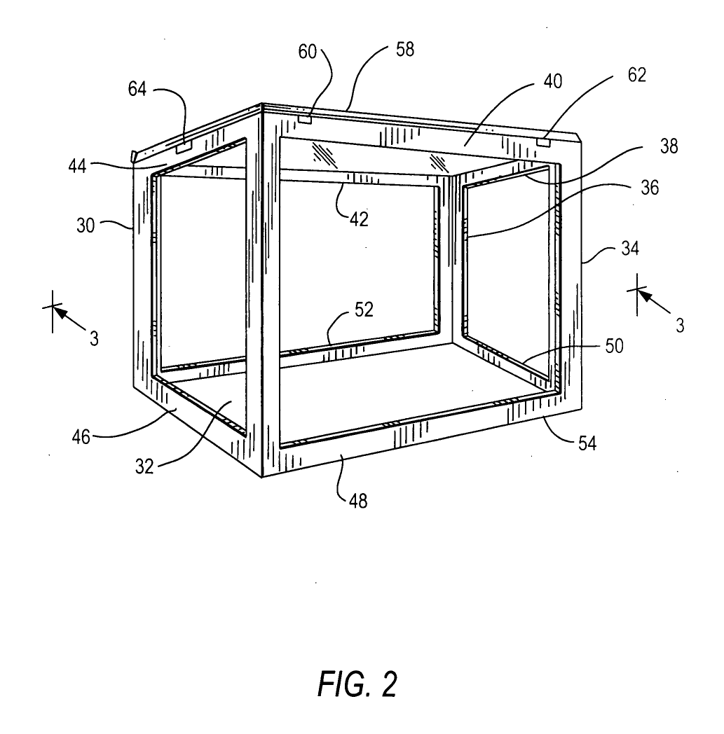

FIG. 2 shows the display unit 14 removed from the self-powered vehicle 12. In the preferred embodiment, the display unit 14 includes a plurality of frame members 30, 32, 34, 36, 38, 40, 42, 44, 46, 48, 50 52 which have slotted portions which will be described presently. The frame members 30, 32, 34, 36, 38, 40, 42, 44, 46, 48, 50, 52 define a rectangular parallelepiped 54 which is mounted on the bed 56 of the self-powered vehicle 12. The attachment of the frame members 30, 32, 34, 36, 38, 40, 42, 44, 46, 48, 50, 52 to the bed 56 of the self-powered vehicle 12 may be accomplished using conventional fasteners such as bolts, which are not illustrated.

The display unit 14 also includes a solid top panel 58 which is shown in FIG. 2 which covers the top portions of the frame members 38, 40, 42, 42, 44. The top panel 58 is attached to the frame 38, 40, 42, 44 members by conventional hinges 60, 62 and latches 64.

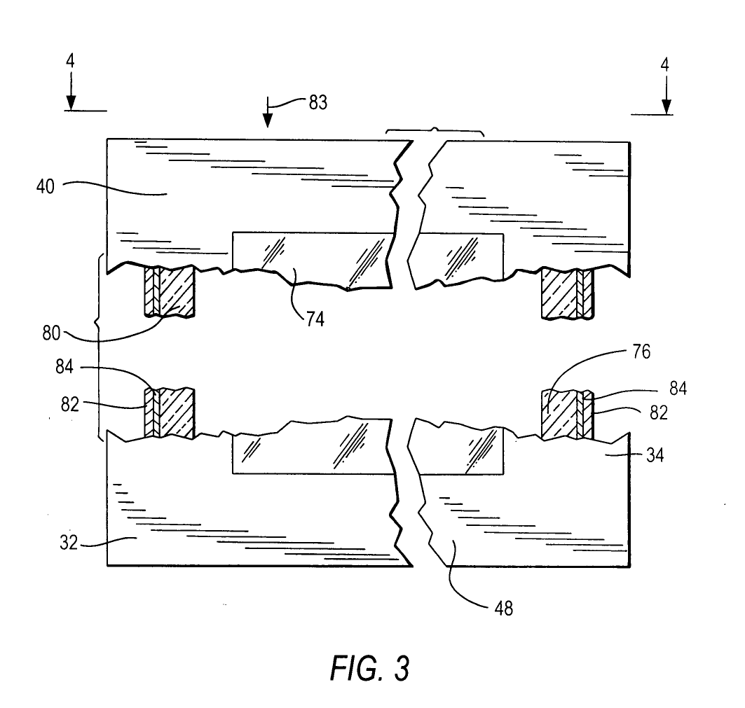

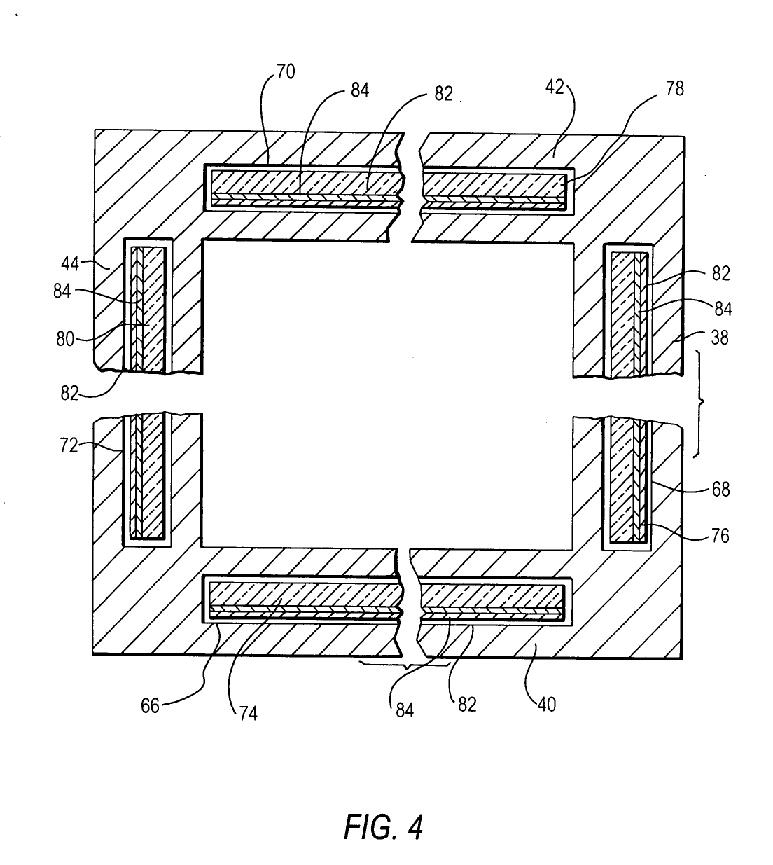

As shown in FIG. 4, when the top panel 58 is opened, the slots 66, 68, 70, 72 may be accessed from the top of the display unit 14. Display panels 74, 76, 78, 80 which in the first embodiment preferably are made of a solid sheet material may be inserted into the slots 66 68, 70, 72 from the top of the display unit 14 in the direction shown by the arrow 83 in FIG. 3.

When the top panel 58 is closed and latched, the display panels 74, 76, 78, 80 are retained.

The top panel 58 may also have a display sheet 82 which is mounted on the top panel 58 by an adhesive layer 84. The display sheet 82 may be viewed from locations which are above the elevation of the system 10.

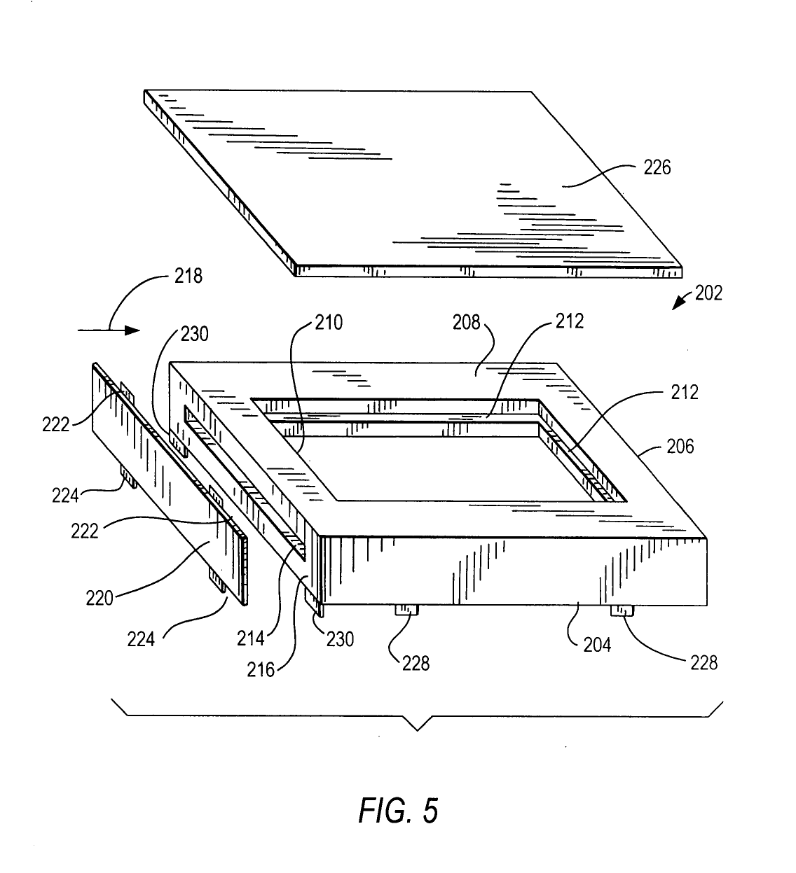

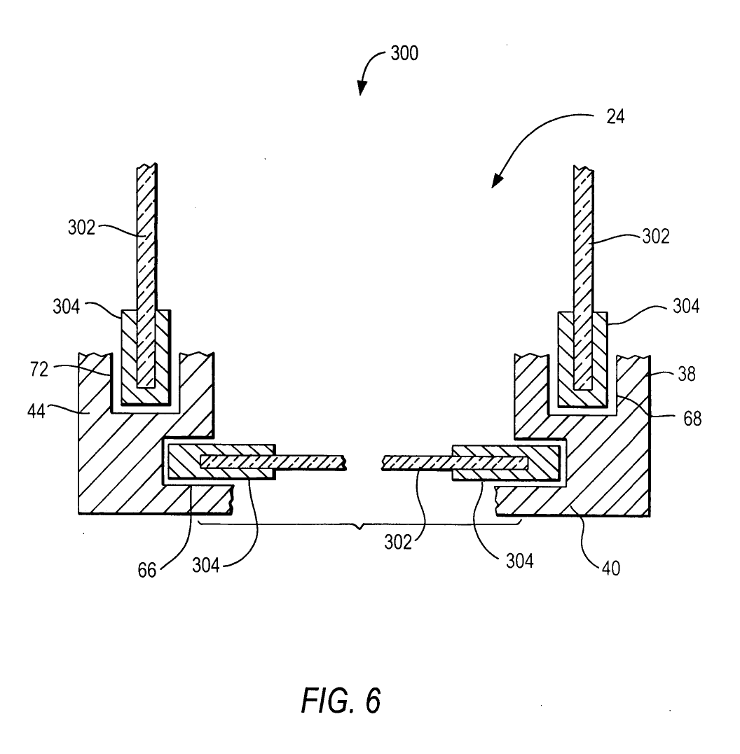

In a second embodiment of the invention which is shown in FIG. 5, the solid top panel 58 of FIG. 2 is replaced by the top panel assembly 202 of FIG. 5. As shown in FIG. 6, the top panel assembly 202 includes four frame members 204, 206, 208, 210 which form a generally rectangular framework. Each of the frame members 204, 206, 208, 210 has a slotted portion 212, 214. The frame member 210 has a slotted portion 214 which may be accessed from the surface 216 of the frame member 210.

A display panel 226 which is identical in construction to the display panels 74, 76, 78, 80 previously described in connection with FIGS. 3 and 4 may be inserted into the top panel assembly 202 in the direction shown by the arrow 218 in FIG. 5. A door panel 220 which is connected to the frame member 210 by hinges 222 and latches 224 close the slot 214 during use thereby securely retaining the display panel 226.

The top panel assembly 202 is mounted on the display unit 14 using conventional hinges 228 and is secured by conventional latches.

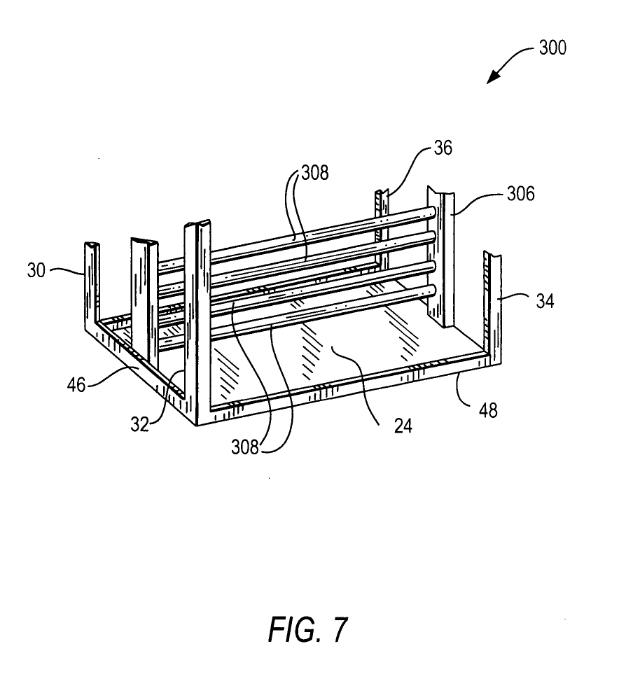

FIGS. 6 and 7 show a third embodiment of the invention 300 in which the solid display panels 74, 76, 78, 80 previously described in connection with FIGS. 3 and 4 are replaced by translucent or transparent panels 302 which are mounted in the frames 304. The frames 304 are slideably mounted in slot portions 66, 68, 72 in the frame members typically shown as 38, 40, 44 in a manner similar to that which has been previously described. The third embodiment of the invention 300 includes a light source 306 which preferably may be a set of fluorescent lamps 308 which are mounted in an interior area 24 which is defined by the frame members 30, 32, 34, 36, 38, 40, 42, 44, 46, 48, 50, 52 as shown in FIG. 7. The light source 306 and the translucent panels 302 provide an illuminated display for increased visibility and operation during night time hours.

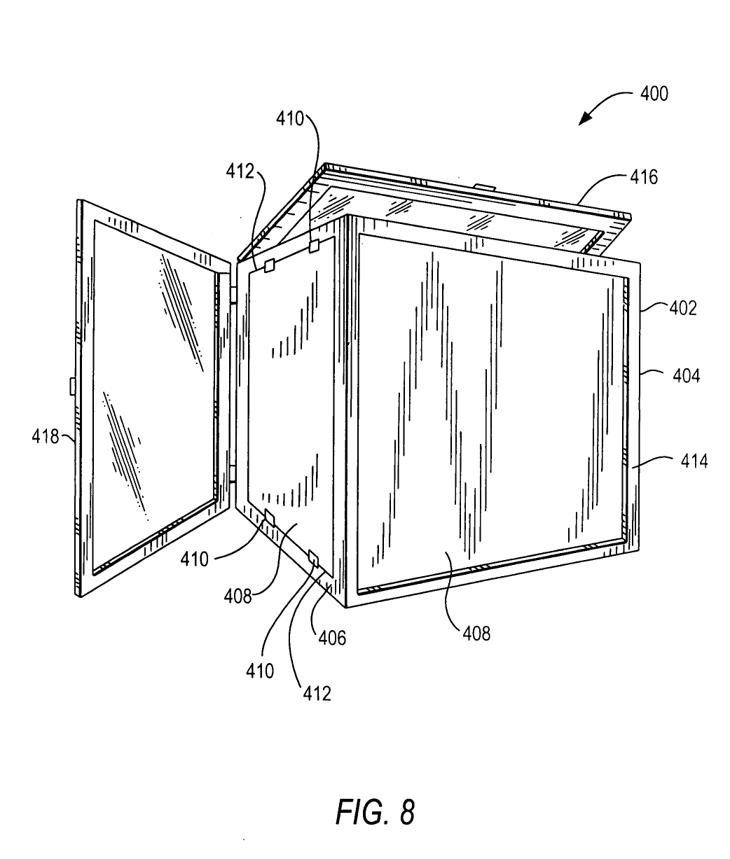

FIG. 8 shows a fourth embodiment of the invention 400 in which the display unit 402 comprises rigid solid panels 404, 406 which form a closed rigid prism. The display unit 402 is mounted on the bed 56 of the self-propelled vehicle 12 in a conventional manner as described above. The panels 404, 406 each have a smooth surface which facilitates attachment of display sheets 408 by means of an adhesive layer or by means of clips 410 which grasp the edges 412 of the display sheets 408. The display sheets 408 may be imprinted with a variety of informational or advertising indicia. The display unit 402 includes frame assemblies 414, 416, 418 which cover the panels and which cover the edges 412 of the display sheets 408. The frame assemblies 414, 416, 418 thus provide a measure of protection for the edges 412 of the display sheets 408 and thereby prevent tearing due to wind damage or misuse.

Many variations and modifications may be made to the above embodiment of the invention without departing from the spirit and principles of the invention.

In certain embodiments, the mobile variable display system may have display panels that rotate to show different billboards. Rotation may be limited to a single or all of the plurality of display panels within the frame members. Alternatively, the display panels may be in the form of plasma screens wherein informational or advertising indicia is delivered in video form thereby providing a stream of animation.

What is claimed is:

1. A mobile variable display system comprising:
a self-powered vehicle having propulsion means, steering means and operation accommodation means, and
a display unit mounted on said self-powered vehicle and a plurality of display panels mounted on said display unit.

2. A mobile variable display system as claimed in claim 1 wherein said self-powered vehicle comprises:
a forward portion;
a bed portion; and
a rear portion and wherein said steering means comprises a single steerable wheel disposed on said forward portion, with said bed portion disposed on said rear portion and with said display unit disposed on said bed portion.

3. A mobile variable display system as claimed in claim 1 wherein said display unit comprises:
a plurality of frame members with said frame members forming a rectangular parallel piped with selected frame members comprising:
slotted portions and with said display unit further comprising a plurality of display panels, with said plurality of display panels disposed in said slotted portions.

4. A mobile variable display system as claimed in claim 1 wherein the vehicle supported and steerable with a single front wheel under a cab section and supported onto wheels under a rear section.

5. A mobile variable display system as claimed in claim 3 wherein the plurality of frame members and display members are at least three in number.

6. A mobile variable display system as claimed in claim 3 wherein the display panel comprise a billboard poster display of information or advertising indicia mounted on a flat sheet-like support.

7. A mobile variable display system as claimed in claim 3 wherein the vehicle has a cab with doors, the doors carrying additional advertising material.

8. A mobile variable display system as claimed in claim 3 further comprising a roof display panel comprising a billboard poster display of informational or advertising indicia viewable from elevated locations above the vehicle.

9. A mobile variable display system as claimed in claim 3 wherein the plurality of frame members is four and further comprising a solid top panel covering the top portions of the four frame members.

10. A mobile variable display system as claimed in claim 9 wherein the slotted portions can be accessed by displacing the solid top panel.

11. A mobile variable display system as claimed in claim 9 wherein the display panels are removable from the slotted portions through an opening available by shifting or removing the top panel.

12. A mobile variable display system as claimed in claim 3 further comprising a top panel arranged perpendicularly above the plurality of frame members, a display sheet with informational or advertising indicia being mounted onto the top panel by an adhesive layer.

13. A mobile variable display system as claimed in claim 3 further comprising a top panel assembly arranged perpendicularly above the plurality of frame members and formed with a slot, a top display panel being inserted into the top panel assembly through the slot, a door panel removably covering a mouth of the slot to securely retain the top display panel.

14. A mobile variable display system as claimed in claim 3 wherein the plurality of display panels is translucent or transparent.

15. A mobile variable display system as claimed in claim 14 further comprising a light source mounted in an interior area behind the plurality of frame members.
